(19) United States
(12) Patent Application Publication
(10) Pub. No.: US 2025/0303310 A1
(43) Pub. Date: Oct. 2, 2025

(54) MESSAGE PROCESSING METHOD AND APPARATUS, TERMINAL, AND STORAGE MEDIUM

(71) Applicant: Tencent Technology (Shenzhen) Company Limited, Shenzhen (CN)

(72) Inventor: Liang ZHANG, Shenzhen (CN)

(21) Appl. No.: 19/235,395

(22) Filed: Jun. 11, 2025

Related U.S. Application Data
(63) Continuation of application No. PCT/CN2024/080670, filed on Mar. 8, 2024.

(30) Foreign Application Priority Data
May 6, 2023 (CN) 202310505664.2

(51) Int. Cl. A63F 13/87; A63F 13/533

(52) U.S. Cl. CPC A63F 13/87; A63F 13/533; A63F 2300/572

(57) ABSTRACT

Embodiments of this application disclose a message processing method performed at a terminal. The method includes: displaying a message setting interface of a first artificial intelligence (AI) object in a game application, the first AI object acting as a companion of the first account; acquiring a text inputted through the text input operation by a user of the terminal; in response to a message transmitting operation triggered in the message setting interface, converting the text into a first broadcast message, semantics of the first broadcast message being consistent with semantics of the text and a language style of the first broadcast message being consistent with a language style of the first AI object; and transmitting the first broadcast message to a second account of the game application for displaying the first broadcast message at a terminal corresponding to the second account using an identity of the first AI object.

### CROSS-REFERENCE TO RELATED APPLICATIONS

This application is a continuation application of PCT Patent Application No. PCT/CN2024/080670, entitled “MESSAGE PROCESSING METHOD AND APPARATUS, TERMINAL, AND STORAGE MEDIUM” filed on Mar. 8, 2024, which_claims priority to Chinese Patent Application No. 2023105056642, entitled “MESSAGE PROCESSING METHOD AND APPARATUS, TERMINAL, AND STORAGE MEDIUM” filed with the China National Intellectual Property Administration on May 6, 2023, both of which are incorporated by reference in their entirety.

### FIELD OF THE TECHNOLOGY

Embodiments of this application relate to the technical field of Internet, and in particular, to a message processing technology.

### BACKGROUND OF THE DISCLOSURE

In a multiplayer online role-playing game (MMORPG), a player may control a virtual object to participate in various activities. In addition, to enhance social interaction, the electronic game not only supports players to transmit messages to each other for chatting, but also supports a player to transmit a broadcast message in a server-wide channel, and notifies each player using the same server as the player of the broadcast message.

In the related art, the player usually needs to autonomously edit text content of the broadcast message. However, this manner is relatively rigid and lacks entertainment values. In addition, a broadcast message obtained in this manner usually reflects a personal style of the player, rather than being consistent well with the game style, easily resulting in a poor social experience for the user.

### SUMMARY

Embodiments of this application provide a message processing method and apparatus, a terminal, and a storage medium, which can improve entertainment values of transmitting a broadcast message, improve interaction between a player and an artificial intelligence (AI) object, and help promote human-computer interaction. In addition, it can be ensured that the transmitted broadcast message is consistent with a game style, thereby helping improve the social experience of a user. Technical solutions are as follows.

According to an aspect, a message processing method is performed by a terminal and the method includes the following operations:
displaying a message setting interface of a first artificial intelligence (AI) object in a game application, wherein the first AI object is bound to a first account and the first account is an account currently logged into the game application, and the first AI object acts as a companion of the first account in the game application;
receiving a text input operation triggered in the message setting interface, and acquiring a text inputted through the text input operation by a user of the terminal;
in response to a message transmitting operation triggered in the message setting interface, converting the text into a first broadcast message, wherein semantics of the first broadcast message is consistent with semantics of the text, and a language style of the first broadcast message is consistent with a language style of the first AI object; and
transmitting the first broadcast message to a second account of the game application for displaying the first broadcast message at a terminal corresponding to the second account using an identity of the first AI object.

According to another aspect, a terminal is provided, including a processor and a memory, the memory having at least one computer program stored therein, and the at least one computer program being loaded and executed by the processor to implement operations performed in the message processing method according to the foregoing aspects.

According to another aspect, a non-transitory computer-readable storage medium is provided, having at least one computer program stored therein, and the at least one computer program being loaded and executed by a processor to implement operations performed in the message processing method according to the foregoing aspects.

According to the solutions provided in the embodiments of this application, an account of the player has an AI object bound thereto. When a broadcast message is transmitted, after the player inputs a text, the broadcast message may be automatically generated. The broadcast message has semantics consistent with that of the text and has a language style consistent with that of the AI object. Then, the broadcast message is transmitted using an identity of the AI object. This is equivalent to that the player provides content expected to be transmitted, and the AI object reorganizes the language and transmits the broadcast message instead of the player according to the language style of the AI object. Thus, the manner of transmitting the broadcast message improves the entertainment value, thereby improving interaction between the player and the AI object, and helping promote human-computer interaction. In addition, since the language style of the AI object is closer to the game style, the transmitted broadcast message may also be closer to the game style, thereby improving the social experience of the user.

### BRIEF DESCRIPTION OF THE DRAWINGS

FIG. 1 is a schematic diagram of an implementation environment according to an embodiment of this application.

FIG. 2 is a flowchart of a message processing method according to an embodiment of this application.

FIG. 3 is a flowchart of a message processing method according to an embodiment of this application.

FIG. 4 is a schematic diagram of a message box according to an embodiment of this application.

FIG. 5 is a schematic diagram of a broadcast message according to an embodiment of this application.

FIG. 6 is a schematic diagram of a message setting interface according to an embodiment of this application.

FIG. 7 is a schematic diagram of a message interface according to an embodiment of this application.

FIG. 8 is a flowchart of a binding method according to an embodiment of this application.

FIG. 9 is a schematic diagram of an AI object interface according to an embodiment of this application.

FIG. 10 is a schematic diagram of a name modification interface according to an embodiment of this application.

FIG. 11 is a flowchart of a message processing method according to an embodiment of this application.

FIG. 12 is a schematic diagram of a sound effect setting interface according to an embodiment of this application.

FIG. 13 is a schematic diagram of a chat interface according to an embodiment of this application.

FIG. 14 is a schematic diagram of a lobby interface according to an embodiment of this application.

FIG. 15 is a flowchart of a message processing method according to an embodiment of this application.

FIG. 16 is a schematic diagram of a function bar according to an embodiment of this application.

FIG. 17 is a schematic diagram of a detail interface according to an embodiment of this application.

FIG. 18 is a schematic diagram of a chat interface according to an embodiment of this application.

FIG. 19 is a schematic diagram of a broadcast reply interface according to an embodiment of this application.

FIG. 20 is a schematic diagram of a broadcast message according to an embodiment of this application.

FIG. 21 is a schematic diagram of a blocking interface according to an embodiment of this application.

FIG. 22 is a schematic diagram of a lobby interface according to an embodiment of this application.

FIG. 23 is a schematic diagram of a broadcast reply interface according to an embodiment of this application.

FIG. 24 is a schematic structural diagram of a message processing apparatus according to an embodiment of this application.

FIG. 25 is a schematic structural diagram of another message processing apparatus according to an embodiment of this application.

FIG. 26 is a schematic structural diagram of a terminal according to an embodiment of this application.

### DESCRIPTION OF EMBODIMENTS

To make the objectives, technical solutions, and advantages of embodiments of this application clearer, implementations of this application will be described in further detail below with reference to the accompanying drawings.

The terms “first”, “second”, and the like used in this application may be used for describing various concepts in this specification. However, the concepts are not limited by the terms unless otherwise specified. The terms are merely used for distinguishing one concept from another concept. For example, without departing from the scope of this application, a first AI object may be referred to as a second AI object, and similarly, the second AI object may be referred to as the first AI object.

The term “at least one” refers to one or more. For example, at least one AI object may be an integer number of AI objects equal to or greater than one, such as one AI object, two AI objects, or three AI objects. The term “a plurality of” refers to two or more. For example, a plurality of AI objects may be an integer number of AI objects equal to or greater than two, such as two AI objects or three AI objects. The term “each” refers to each of the at least one. For example, each AI object refers to each of a plurality of AI objects, and if the plurality of AI objects are three AI objects, each AI object refers to each of the three AI objects.

In implementations of this application, data related to accounts and AI objects are involved. When the embodiments of this application are applied to specific products or technologies, permission or consent of the user needs to be obtained, and acquisition, use, and processing of the relevant data need to comply with relevant laws, regulations, and standards of relevant countries and regions.

AI to which this application relates is a theory, method, technology, and application system that uses a digital computer or a machine controlled by the digital computer to simulate, extend, and expand human intelligence, perceive an environment, acquire knowledge, and use knowledge to obtain an optimal result. In other words, AI is a comprehensive technology in computer science and attempts to understand the essence of intelligence and produce a new intelligent machine that can react in a manner similar to human intelligence. AI is to study the design principles and implementation methods of various intelligent machines, to enable the machines to have the functions of perception, reasoning, and decision-making.

A virtual scene related to this application may be configured for simulating a three-dimensional virtual space. The three-dimensional virtual space may be an open space. For example, the virtual scene may include the sky, the land, the ocean, and the like. The land may include environmental elements such as a desert and a city. The virtual scene may further include a virtual item, for example, a prop such as a throwing item, a building, a mount, or a virtual weapon required for a virtual object to equip itself or fight against other virtual objects. The virtual scene may further be configured for simulating environments in different weather, such as sunny, rainy, foggy, or black. Various scene elements enhance the diversity and realness of the virtual scene.

The user may control a virtual object to move in the above-mentioned virtual scene. The virtual object is a virtual image representing the user in the virtual scene. The virtual image may be in any form, such as a person or an animal. This is not limited in this application. Using an electronic game as an example, the electronic game may be an MMORPG. A player may control a virtual object to participate in various activities in a virtual scene, and participate in various game battles.

In the embodiments of this application, an electronic game scene is used as an example. The user downloads and installs the electronic game on a terminal in advance. After detecting the above-mentioned operations, the terminal downloads a game configuration file of the electronic game. The game configuration file includes an application program, interface display data, virtual scene data, or the like of the electronic game so that the user invokes the game configuration file when logging into the electronic game on the terminal, so as to render and display an interface of the electronic game and respond to related user operations. After the electronic game is installed, the user performs a touch operation on the terminal based on the electronic game. After detecting the touch operation, the terminal determines game data corresponding to the touch operation, and renders and displays the game data. The game data may include virtual scene data, behavior data of virtual objects in the virtual scene, and the like.

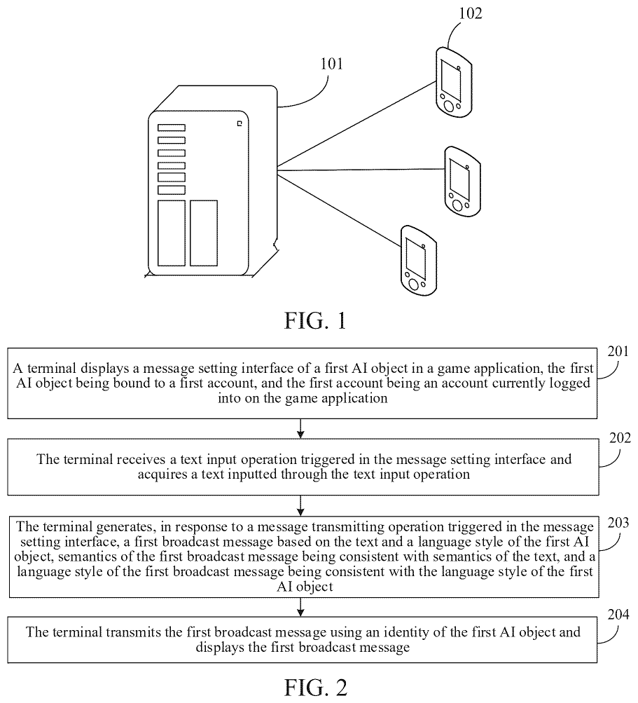

FIG. 1 is a schematic diagram of an implementation environment according to an embodiment of this application. The implementation environment includes a server 101 and a plurality of terminals. A game application served by the server 101 is run on the plurality of terminals, and FIG. 1 uses three terminals as an example. Each terminal and the server 101 are directly or indirectly communicated in a wired or wireless communication manner.

In this embodiment of this application, the server 101 provides background support for the game application in the plurality of terminals. Using a terminal 102 in the plurality of terminals as an example, the game application in the terminal 102 is logged in with a first account, and the first account is bound to a first AI object. The terminal 102 may generate, based on text inputted by a user, a broadcast message that has semantics consistent with that of the text and a language style consistent with that of the first AI object, and then display the broadcast message transmitted using an identity of the first AI object. Meanwhile, the terminal 102 further transmits the broadcast message to the server 101, and the server 101 transmits the broadcast message to the plurality of terminals so that other terminals also display the broadcast message transmitted by the first AI object.

In a possible implementation, the server 101 is an independent physical server, a server cluster or a distributed system including a plurality of physical servers, or a cloud server that provides basic cloud computing services such as a cloud service, a cloud database, cloud computing, a cloud function, cloud storage, a network service, cloud communication, a middleware service, a domain name service, a security service, a content delivery network (CDN), or a big data and AI platform. In a possible implementation, the plurality of terminals may be smartphones, tablet computers, notebook computers, desktop computers, smart speakers, smart televisions, smart watches, in-vehicle terminals, or the like, but are not limited thereto.

The message processing method provided in the embodiments of this application may be applied to a scene in which the broadcast message is transmitted in the game application.

For example, the game application running on the terminal is logged in with a first account, and the first account is bound with an AI object. Messages transmitted by players in a world channel are displayed in a lobby interface of the game application. A player may transmit a broadcast message in the world channel, and the broadcast message may be notified to server-wide players. In this embodiment of this application, the player may transmit the broadcast message using an AI object. The player only needs to provide text. Then, the AI object reorganizes the language based on the text to obtain a broadcast message that has semantics the same as that of the text and a language style consistent with that of the AI object. The AI object transmits the broadcast message, and server-wide players may browse the broadcast message in the world channel. In this way, the AI object is used as a speaker of the player and transmits the broadcast message instead of the player, thereby improving the entertainment value of transmitting the broadcast message. In addition, since the language style of the AI object is more consistent with a game style, it may be ensured that the broadcast message in the world channel is more consistent with the game style, which helps improve the social experience of the player.

FIG. 2 is a flowchart of a message processing method according to an embodiment of this application. This embodiment of this application is performed by a terminal. Referring to FIG. 2, the method includes the following operations.

201: The terminal displays a message setting interface of a first AI object in a game application, the first AI object being bound to a first account, and the first account being an account currently logged into on the game application.

In this embodiment of this application, an AI object is provided in the game application, and the account in the game application may establish a binding relationship with the AI object. Using the first account currently logged into on the game application as an example, the first AI object is bound with the first account.

The AI object is alternatively referred to as an AI companion, is an AI agent having independent personality and traits in a world background of the game application, and can establish a binding relationship with an account of the player. The AI object may be in any form, such as a character, an animal, a cartoon image, a robot, or the like. This is not limited in this embodiment of this application. The AI object is an object controlled based on AI and is different from a virtual object controlled by a user operation. The AI object is one of non-player characters (NPCs) in the electronic game. The AI object can autonomously have a dialog with the player using AI as technical support, thereby improving the social entertainment value in the game application.

The terminal displays the message setting interface of the first AI object in the game application, and the message setting interface is configured for setting a broadcast message transmitted using an identity of the first AI object.

202: The terminal receives a text input operation triggered in the message setting interface and acquires a text inputted through the text input operation.

The player performs the text input operation in the message setting interface to input a text. Correspondingly, the terminal acquires the text inputted by the player, and the text is content that the player expects to transmit.

203: The terminal generates, in response to a message transmitting operation triggered in the message setting interface, a first broadcast message based on the text and a language style of the first AI object, semantics of the first broadcast message being consistent with semantics of the text, and a language style of the first broadcast message being consistent with the language style of the first AI object.

The player may trigger the message transmitting operation after inputting text. The terminal converts, in response to the message transmitting operation, the text inputted by the player into the first broadcast message. The semantics of the first broadcast message is the same as the semantics of the text, and the language style of the first broadcast message is the same as the language style of the first AI object. This is equivalent to that based on the text inputted by the player, the language is reorganized without changing the semantics of the text, so as to obtain the first broadcast message conforming to the language style of the first AI object.

204: The terminal transmits the first broadcast message using an identity of the first AI object and displays the first broadcast message.

After generating the first broadcast message, the terminal displays the first broadcast message transmitted using the identity of the first AI object. In some embodiments, in the game application, the first broadcast message is alternatively referred to as a loudspeaker message. The loudspeaker message is a message published in the world channel. Each account in the game application may receive the loudspeaker message published in the world channel. Then, each account in the game application may see the first broadcast message transmitted by the first AI object.

In the method provided in this embodiment of this application, the account of the player has an AI object bound thereto. When a broadcast message is transmitted, after the player inputs a text, the broadcast message may be automatically generated. The broadcast message has semantics consistent with that of the text and has a language style consistent with that of the AI object. Then, the broadcast message is transmitted using an identity of the AI object. This is equivalent to that the player provides content expected to be transmitted, and the AI object reorganizes the language and transmits the broadcast message instead of the player according to the language style of the AI object. Thus, the manner of transmitting the broadcast message improves the entertainment value, thereby improving interaction between the player and the AI object, and helping promote human-computer interaction. In addition, since the language style of the AI object is closer to the game style, the transmitted broadcast message may also be closer to the game style, thereby improving the social experience of the user.

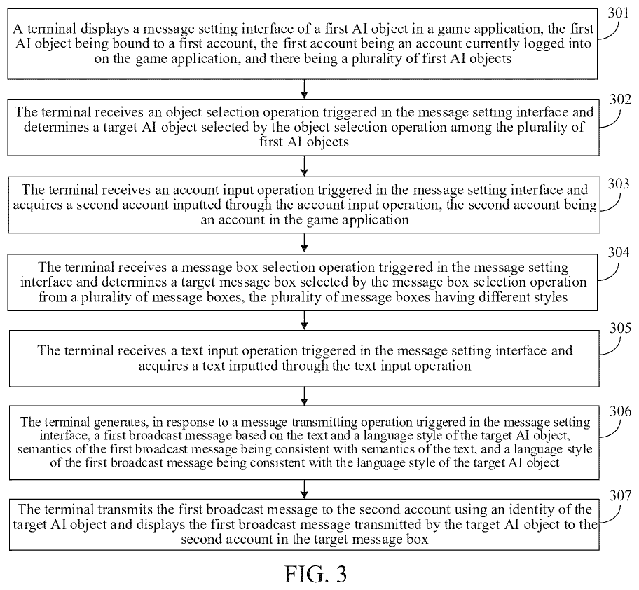

The foregoing embodiment of FIG. 2 briefly describes a process in which the AI object transmits the broadcast message. A detailed process in which the AI object transmits the broadcast message refers to the following embodiment shown in FIG. 3.

FIG. 3 is a flowchart of a message processing method according to an embodiment of this application. This embodiment of this application is performed by a terminal. Referring to FIG. 3, the method includes the following operations.

301: The terminal displays a message setting interface of a first AI object in a game application, the first AI object being bound to a first account, the first account being an account currently logged into on the game application, and there being a plurality of first AI objects.

The first AI object is an AI object bound to the first account. The first account may be bound to a plurality of first AI objects, and each first AI object has corresponding attributes such as a language style, an appearance, an age, a gender, and a name.

302: The terminal receives an object selection operation triggered in the message setting interface and determines a target AI object selected by the object selection operation among the plurality of first AI objects.

The message setting interface is provided with a plurality of first AI objects. In this embodiment of this application, the target AI object is used as an example. The target AI object may be any one of the plurality of first AI objects. If the player wants to transmit the broadcast message using the identity of the target AI object, the player performs the object selection operation based on the plurality of first AI objects in the message setting interface, and the terminal determines the selected target AI object based on the object selection operation.

In a possible implementation, the message setting interface displays avatars of the plurality of first AI objects, and the object selection operation on the target AI object refers to an operation of selecting an avatar of the target AI object. In another possible implementation, the message setting interface displays object identifiers of the plurality of first AI objects, and the object selection operation on the target AI object refers to an operation of selecting an object identifier of the target AI object.

In this embodiment of this application, when the account is bound with a plurality of AI objects, the player may autonomously select which AI object to use to transmit the broadcast message, thereby improving the flexibility of transmitting the broadcast message, and may randomly select a language style of the transmitted broadcast message.

303: The terminal receives an account input operation triggered in the message setting interface and acquires a second account inputted through the account input operation, the second account being an account in the game application.

If the player wants the AI object to transmit the broadcast message to the second account, the player may perform the account input operation in the message interface to input the second account. The second account is an account different from the first account in the game application. If the player does not input the second account, a receiver is not specified when the AI object transmits the broadcast message. In other words, the broadcast message is transmitted to all players in the game application and is not targeted for a particular player.

In a possible implementation, the message setting interface includes an account input box. The account input box includes accounts that have interacted with the target AI object. If these accounts include the second account, the player directly selects the second account from these accounts. If these accounts do not include the second account, the player may manually input the second account into the account input box.

In this embodiment of this application, when the broadcast message is set, an account to which the broadcast message is transmitted may be specified, thereby improving the pertinence of the broadcast message transmitted by the AI object, that is, the broadcast message is transmitted to a specific account in a targeted manner, thereby improving the flexibility of interaction based on the broadcast message in the world channel.

304: The terminal receives a message box selection operation triggered in the message setting interface and determines a target message box selected by the message box selection operation from a plurality of message boxes, the plurality of message boxes having different styles.

The player may further set a style of the message box configured for carrying the broadcast message. The message setting interface includes a plurality of message boxes. The plurality of message boxes have different styles. In this embodiment of this application, the target message box is used as an example. The target message box may be any one of the plurality of message boxes. If the player wants to carry the broadcast message using the target message box, the player performs the message box selection operation on the target message box in the message setting interface, and the terminal determines the selected target message box based on the message box selection operation.

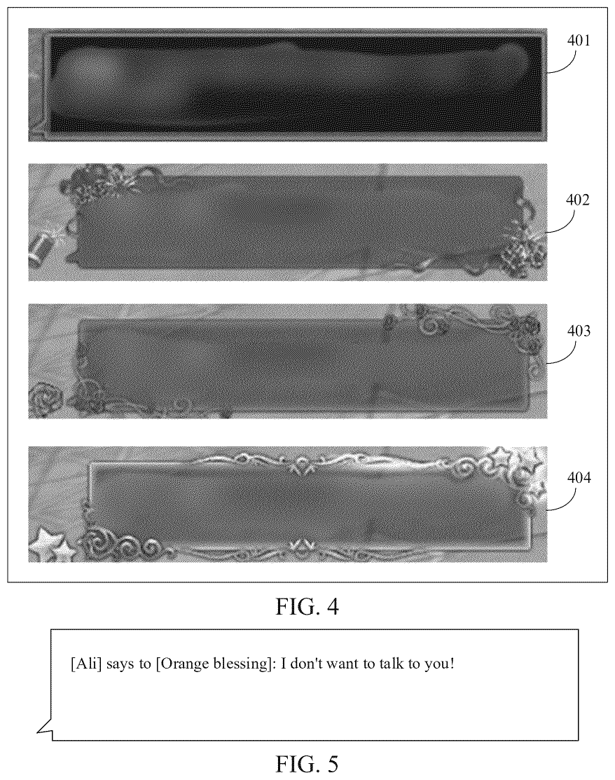

FIG. 4 is a schematic diagram of a message box according to an embodiment of this application. As shown in FIG. 4, styles of a message box 401, a message box 402, a message box 403, and a message box 404 are different. The message box 401 is an ordinary message box, the message box 402 is a celebration message box, the message box 403 is a rose message box, and the message box 404 is a starlight message box.

305: The terminal receives a text input operation triggered in the message setting interface and acquires a text inputted through the text input operation.

The player performs the text input operation in the message setting interface to input a text, and the terminal acquires the text inputted by the player. The text is content that the player expects to transmit.

306: The terminal generates, in response to a message transmitting operation triggered in the message setting interface, a first broadcast message based on the text and a language style of the target AI object, semantics of the first broadcast message being consistent with semantics of the text, and a language style of the first broadcast message being consistent with the language style of the target AI object.

After completing setting operations (i.e., the above-mentioned object selection operation, account input operation, and message box selection operation) in the message setting interface, the player performs the message transmitting operation. The terminal generates, in response to the message transmitting operation, the first broadcast message that has semantics consistent with that of the text and a language style consistent with that of the target AI object.

In a possible implementation, the terminal determines, in response to the message transmitting operation, a target text conversion model whose language style is consistent with the language style of the target AI object among a plurality of text conversion models, and invokes the target text conversion model to perform style conversion on the text and obtain the first broadcast message having the language style of the target AI object.

A database stores a plurality of pre-trained text conversion models. The plurality of text conversion models is configured for converting texts into specific language styles. Language styles corresponding to the text conversion models are different. For example, the language styles may include plain and straightforward, subtle and tactful, humorous and entertaining, childlike, or bold and unrestrained. The terminal first determines the language style of the selected target AI object, then determines the target text conversion model whose language style is consistent with the language style of the target AI object among the plurality of text conversion models, and further inputs the text into the target text conversion model. The target text conversion model performs style conversion on the text to obtain the text having the language style of the target AI object. The outputted text is the first broadcast message.

In this embodiment of this application, the text conversion model is invoked so that a style of a text inputted by the player may be converted to obtain a broadcast message whose language style is consistent with the language style of the first AI object. Thus, the broadcast message is automatically generated, and the player does not need to imitate the language style of the first AI object to personally edit the broadcast message, thereby improving the efficiency of generating the broadcast message. In addition, the text conversion model may ensure that the language style of the generated broadcast message is consistent with the language style of the first AI object, that is, the generated broadcast message may be ensured to have relatively high quality.

In a possible implementation, the terminal acquires, in response to the message transmitting operation, a first intimacy degree. The first intimacy degree is an intimacy degree between the first account and the second account. The terminal generates the first broadcast message based on the text, the language style of the first AI object, and the first intimacy degree, and an emotional positivity degree of the first broadcast message is positively correlated with the first intimacy degree.

The terminal maintains an intimacy degree between the first account and another account. The intimacy degree may be comprehensively determined based on information in multiple dimensions, for example, whether the first account and the second account belong to the same group, the number of times that the first account and the second account participate in battles as enemies, the number of times that the first account and the second account participate in battles as teammates, the number of times that the first account and the second account transmit interaction messages, and the number of times that the first account and the second account give gifts to each other.

Since the broadcast message is transmitted to the second account, and the target AI object is an AI object bound to the first account, an attitude represented by the target AI object through the broadcast message reflects an attitude of the first account toward the second account. Correspondingly, when the broadcast message is generated, the intimacy degree between the first account and the second account is further to be considered. If the intimacy degree between the first account and the second account is relatively high, the emotional positivity degree of the generated broadcast message is relatively high, and if the intimacy degree between the first account and the second account is relatively low, the emotional positivity degree of the generated broadcast message is relatively low.

In this embodiment of this application, when the broadcast message is specified to be transmitted to the second account, when the broadcast message is generated, the intimacy degree between the first account and the second account may further be considered so that the generated broadcast message has corresponding emotional responses for different accounts, thereby making the process of generating the broadcast message more intelligent, improving vividness of the generated broadcast message, and preventing the generated broadcast message from being excessively rigid.

In a possible implementation, the terminal deletes, in response to the message transmitting operation, a blocked word from the text when the text includes the blocked word, to obtain a processed text, and further generates the first broadcast message based on the processed text and the language style of the first AI object. The semantics of the first broadcast message is consistent with semantics of the processed text.

The terminal maintains a blocked word library. The blocked word library includes a plurality of blocked words. The blocked word is a word that is not allowed to be transmitted in the game application, for example, a word that expresses malicious information. If the text inputted by the player includes a blocked word, the blocked word needs to be first deleted from the text, and then a broadcast message is generated based on a text after deleting the blocked word, thereby avoiding carrying the blocked word in the generated broadcast message, ensuring that the generated broadcast message is a regular message, and avoiding conveying malicious information through the broadcast message, so as to better maintain a social environment of the game application.

307: The terminal transmits the first broadcast message to the second account using an identity of the target AI object and displays the first broadcast message transmitted by the target AI object to the second account in the target message box.

After generating the first broadcast message, the terminal transmits the first broadcast message to the second account using the identity of the target AI object and displays the first broadcast message transmitted by the target AI object to the second account in the target message box.

FIG. 5 is a schematic diagram of a broadcast message according to an embodiment of this application. As shown in FIG. 5, a name of a target AI object is “Ali”, a name of a second account is “Orange blessing”, and a first broadcast message is “I don't want to talk to you!”. Therefore, the terminal displays “[Ali] says to [Orange blessing]: I don't want to talk to you!” in a target message box.

In a possible implementation, the terminal transmits an object identifier of the target AI object, the second account, a message box identifier of the target message box, and the first broadcast message to a game server. The game server transmits the object identifier of the target AI object, the second account, the message box identifier of the target message box, and the first broadcast message to another terminal (where a game application is run, and a corresponding account is logged into on the game application). The another terminal determines the target AI object according to the object identifier, determines the target message box according to the message box identifier, and then displays the first broadcast message transmitted by the target AI object to the second account in the target message box so that players in the game application may all see the first broadcast message transmitted by the target AI object to the second account.

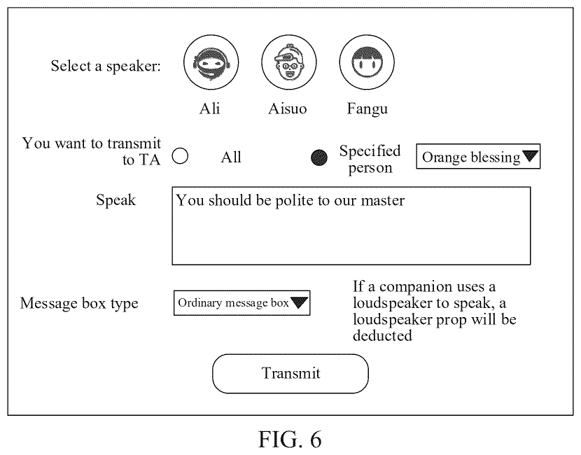

FIG. 6 is a schematic diagram of a message setting interface according to an embodiment of this application. As shown in FIG. 6, a message setting interface displays avatars and names of a plurality of first AI objects bound to a first account. A player may select, in a “select a speaker” column, a target AI object to transmit the broadcast message. The player may set, in a “you want to transmit to TA” column, an account to which the broadcast message is transmitted, i.e., setting a second account. In FIG. 6, an example in which the broadcast message is transmitted to the account “Orange blessing” is used. If the player does not want to specify an object to whom the broadcast message is transmitted, the player selects an “all” option. The player may input, in a “speak” column, a text that the player wants to transmit. For example, the text is “You should be polite to our master”. The player may select, in a “message box type” column, a target message box that the player expects to use.

In a possible implementation, the terminal displays a first broadcast message in a target area. The target area is located above a chat area and configured for displaying any broadcast message. The chat area is configured for displaying chat messages between accounts. For example, the chat message may be a chat message between the first account and another account, a chat message between any two accounts in a team in which the first account is located, or a chat message between any two accounts in a server in which the first account is located. In addition, the chat area is further configured for displaying a system message. For example, the system message is an official notification in a game application or an online message, an offline message, and a killing message of an account in the game application.

In this embodiment of this application, the broadcast message is separately displayed above the chat message, and a display priority of the broadcast message is higher than a display priority of the chat message so that the player may notice the broadcast message at the first time, thereby improving the display effect and spreading effect of the broadcast message.

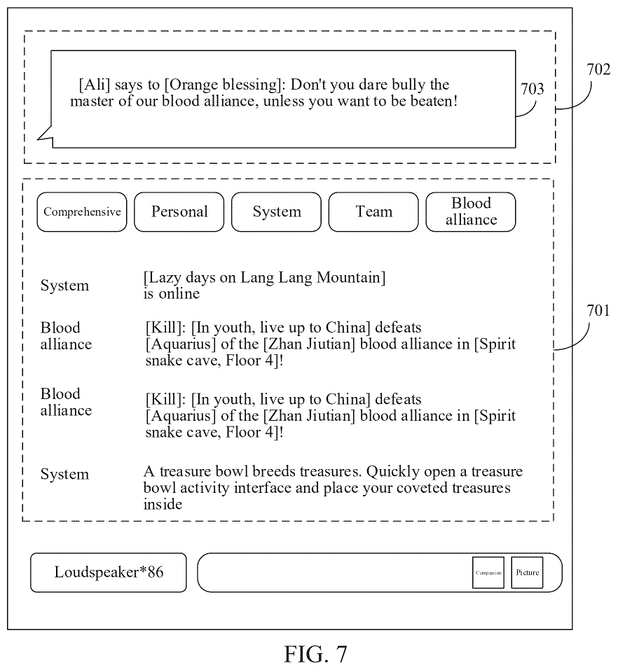

FIG. 7 is a schematic diagram of a message interface according to an embodiment of this application. As shown in FIG. 7, the message interface is a message interface of a world channel. The world channel is a way of supporting mutual communication between accounts using the same server. A chat message transmitted by any account in the world channel may be received by other accounts on the same server. The message interface of the world channel may display chat messages between accounts using the same server, system messages and blood alliance messages on the same server, and any broadcast message. The blood alliance refers to a group formed by players, and the blood alliance message refers to a notification message in the same blood alliance. The message interface includes a chat area 701 and a target area 702, and the target area 702 is located above the chat area 701. The chat area 701 is configured for displaying a chat message, a system message, a blood alliance message, and the like. The target area 702 is configured for displaying a broadcast message. As shown in FIG. 7, a broadcast message 703 is displayed in the target area 702, and the broadcast message 703 is “[Ali] says to [Orange blessing]: Don't you dare bully the master of our blood alliance, unless you want to be beaten!”. The broadcast message 703 is different from other chat messages, system messages, blood alliance messages, and the like, and is separately displayed in the target area 702 so that the player notices the broadcast message 703 in time.

This embodiment of this application is described only using an example in which operation 301 to operation 307 are performed. In another embodiment, at least one of the above-mentioned operation 302, operation 303, or operation 304 may not be performed.

The solution provided in this embodiment of this application may be applied to a strong social game ecology of the MMORPG, and provides a function that an AI object replaces a player to speak in a world channel. In addition, any player may have a dialog with any AI object in the world channel. The AI objects have respective language styles. The player only needs to provide content expected to be transmitted to the AI object, and the AI object may reorganize the language to transmit a loudspeaker message in the world channel for the player, thereby improving the interaction entertainment value.

In the method provided in this embodiment of this application, the account of the player has an AI object bound thereto. When a broadcast message is transmitted, after the player inputs a text, the broadcast message may be automatically generated. The broadcast message has semantics consistent with that of the text and has a language style consistent with that of the AI object. Then, the broadcast message is transmitted using an identity of the AI object. This is equivalent to that the player provides content expected to be transmitted, and the AI object reorganizes the language and transmits the broadcast message instead of the player according to the language style of the AI object. Thus, the manner of transmitting the broadcast message improves the entertainment value, thereby improving interaction between the player and the AI object, and helping promote human-computer interaction. In addition, since the language style of the AI object is closer to the game style, the transmitted broadcast message may also be closer to the game style, thereby improving the social experience of the user.

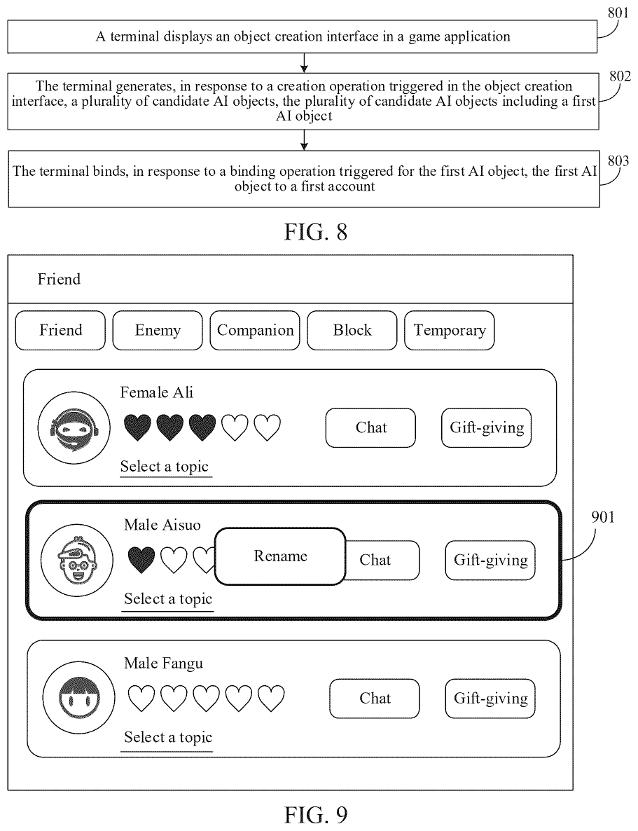

The following embodiment shown in FIG. 8 describes a process of establishing a binding relationship between an account and an AI object. FIG. 8 is a flowchart of a binding method according to an embodiment of this application. This embodiment of this application is performed by a terminal. Referring to FIG. 8, the method includes the following operations.

801: The terminal displays an object creation interface in a game application.

The object creation interface is configured for creating an AI object, and all accounts in the game application may create respective AI objects in the object creation interface.

802: The terminal generates, in response to a creation operation triggered in the object creation interface, a plurality of candidate AI objects, the plurality of candidate AI objects including a first AI object.

Since the AI object in this embodiment of this application is a virtual object not operated and controlled by a user, the AI object may alternatively be referred to as an artificial intelligence-non-player character (AI-NPC). After the player performs the creation operation in the object creation interface, the terminal generates a plurality of candidate AI objects for the player.

The plurality of candidate AI objects have respective attributes such as an appearance, a language style, a gender, and an age. The player may select, among the plurality of generated candidate AI objects, an AI object bound to an account of the player according to the preference.

In a possible implementation, the object creation interface includes a description input box and an object creation option. The terminal receives a text input operation triggered in the description input box, acquires an object description text inputted through the text input operation, and generates, in response to a trigger operation on the object creation option, a plurality of candidate AI objects matching the object description text.

The player inputs the object description text in the object creation interface. The object description text is configured for describing characteristics of the AI object that the player expects to generate. For example, the object description text may describe an appearance and a language style of the AI object. Then, the terminal automatically generates, according to the object description text inputted by the player, the AI object matching the object description text so that the player specifies one-click generation of an AI object having particular characteristics, thereby improving the convenience and flexibility of generating the AI object, and ensuring that the generated AI object meets a requirement of the player.

803: The terminal binds, in response to a binding operation triggered for the first AI object, the first AI object to the first account.

In this embodiment of this application, an example in which the AI object that the player expects to bind is the first AI object is used. The first AI object is any AI object in the plurality of candidate AI objects. If the player subsequently wants to transmit the broadcast message through the first AI object, the player performs the binding operation on the first AI object, and the terminal binds, in response to the binding operation, the first AI object to the first account.

In a possible implementation, the terminal establishes a binding relationship between the first AI object and the first account, and subsequently searches for the AI object bound to the first account according to the binding relationship.

In the method provided in this embodiment of this application, the terminal automatically generates, according to the object description text inputted by the player, candidate AI objects matching the object description text so that the player specifies one-click generation of an AI object having particular characteristics. Then, the player selects, among the plurality of generated candidate AI objects, the AI object bound to the account of the player, thereby improving the convenience and flexibility of generating the AI object, ensuring personalization of the AI object bound to the account of the player, and improving the entertainment value of human-computer interaction.

In another embodiment, the accounts and the AI objects in the game application each have a respective name. To avoid the same name of the AI objects and the same name of the AI object and the player, when the player creates an account, creates an AI object, and combines the servers (i.e., combining players from a plurality of servers into one server), whether the same name is used needs to be detected. If the AI objects have the same name, the name needs to be modified. A scene in which a name of the AI object needs to be modified includes the following three cases.

First case: if a first intimacy degree is less than a third intimacy degree, a name of the first AI object is modified when the name of the first AI object is the same as a name of the second AI object, the first intimacy degree being an intimacy degree between the first AI object and the first account, and the third intimacy degree being an intimacy degree between the second AI object and the bound second account.

The first AI object is bound to the first account, and the second AI object is bound to the second account. There is an intimacy degree between each AI object and the respective bound account. The intimacy degree may be comprehensively determined based on information in multiple dimensions, for example, the number of times that the account transmits interaction messages with the AI object and the number of times that the account gives gifts to the AI object.

If the first AI object and the second AI object have the same name, an AI object whose name needs to be modified may be determined according to the intimacy degrees among the first AI object and the second AI object and their respective bound accounts. That is, the name of the AI object having a relatively low intimacy degree with the bound account is modified, and the name of the AI object having a relatively high intimacy degree with the bound account does not need to be modified, thereby promoting the interaction between the account and the AI object, so as to improve the intimacy degree. This embodiment of this application is described using an example in which the intimacy degree between the first AI object and the bound account is relatively low. The name of the first AI object is modified into an automatically generated name. The automatically generated name is not the same as the names of any AI object and any account. If the player is not satisfied with the name, the name of the first AI object may be modified again.

Second case: if the first intimacy degree is equal to the third intimacy degree, but a first battle parameter is less than a second battle parameter, the name of the first AI object is modified when the name of the first AI object is the same as the name of the second AI object, the first battle parameter representing a battle capability of the first account, and the second battle parameter representing a battle capability of the second account.

Each account in the game application has a respective battle parameter. The battle parameter represents a battle capability of the account. The battle parameter may be comprehensively determined based on information in multiple dimensions, for example, the number of times of battle victories of the account, the number of times that the account assists teammates to defeat enemies, and the number of times that the account defeats enemies.

If the first AI object and the second AI object have the same name, and intimacy degrees among the first AI object and the second AI object and the respective bound accounts are equal, an AI object whose name needs to be modified may be determined according to the battle parameters of the accounts bound to the first AI object and the second AI object. That is, the name of the AI object having a relatively low battle parameter of the bound account needs to be modified, and the name of the AI object having a relatively high battle parameter of the bound account does not need to be modified, thereby promoting positive participation of the account in a battle, so as to improve the battle parameter. This embodiment of this application is described using an example in which the battle parameter of the first account bound to the first AI object is relatively low. The name of the first AI object is modified into an automatically generated name. The automatically generated name is not the same as the names of any AI object and any account. If the player is not satisfied with the name, the name of the first AI object may be modified again.

Third case: the name of the first AI object is modified when the name of the first AI object is the same as a name of any account in the game application.

If the AI object and the account have the same name, the name of the AI object needs to be modified, and the name of the account does not need to be modified.

In this embodiment of this application, through the above-mentioned manner, cases in which AI objects have the same name, and the AI object and the player have the same name are avoided, and the name of the AI object is modified using a proper mechanism, thereby ensuring uniqueness of the name of each AI object and each player in the game application, and facilitating distinguishing the AI objects and the players.

In another embodiment, the player may actively initiate an operation of modifying the name of the AI object. There are the following two manners for requesting to modify the name of the AI object.

First manner: the terminal generates, when the interaction message transmitted by the first account to the first AI object indicates modifying the name of the first AI object, a plurality of candidate names, and modifies, in response to a selection operation on any one of the plurality of candidate names, the name of the first AI object into a selected candidate name.

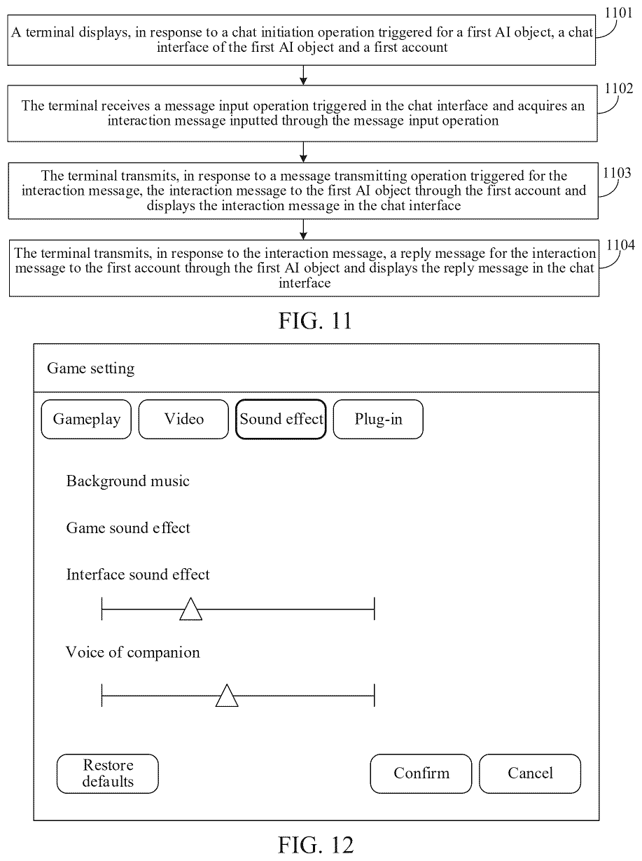

An interaction message may be transmitted between the first account and the first AI object (a detailed process refers to the following embodiment shown in FIG. 11). If the semantics of the interaction message transmitted by the first account is to modify the name of the first AI object, for example, the interaction message transmitted by the first account is “take you a new name”, the terminal may randomly generate a plurality of candidate names, the player selects a candidate name from the plurality of candidate names, and the terminal modifies the name of the first AI object into the selected candidate name.

Second manner: the terminal displays an AI object interface. The AI object interface includes cards of a plurality of first AI objects. The terminal displays a renaming option for the target AI object in response to a trigger operation on a card of the target AI object, generates a plurality of candidate names in response to a trigger operation on the renaming option, and modifies a name of the target AI object into a selected candidate name in response to a selection operation on any one of the plurality of candidate names.

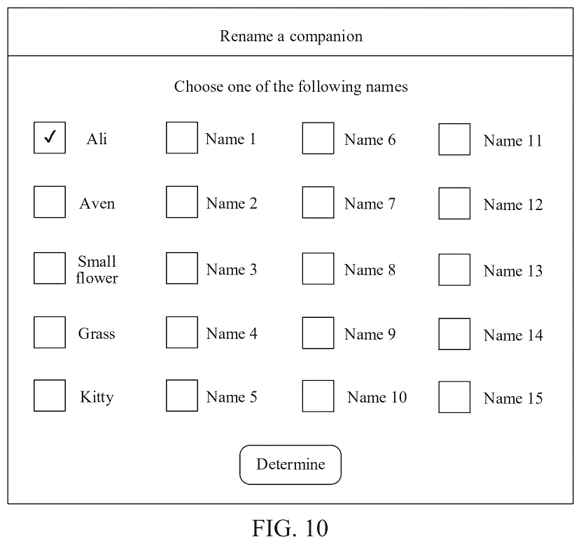

FIG. 9 is a schematic diagram of an AI object interface according to an embodiment of this application. As shown in FIG. 9, the AI object interface includes cards of a plurality of first AI objects, and each card displays an avatar, name, gender, intimacy degree (represented using hearts), “select a topic” option, chat option, and gift-giving option of the AI object. The plurality of first AI objects are “Ali”, “Aisuo”, and “Fangu”, respectively. If the player wants to modify the name of the target AI object “Aisuo”, the player performs a trigger operation (such as a long-press operation) on a card 901 of the target AI object “Aisuo”, and the terminal displays a renaming option of the target AI object in response to the trigger operation. In response to a trigger operation on the renaming option, a candidate name interface shown in FIG. 10 is displayed, and the candidate name interface includes a plurality of optional candidate names. Further, a selection operation may be triggered for any one of the plurality of candidate names, and an “OK” control in the candidate name interface is clicked so that the name of the target AI object may be modified into a selected candidate name.

The following embodiment shown in FIG. 11 describes a process of chatting between an account of a player and an AI object. FIG. 11 is a flowchart of a message processing method according to an embodiment of this application. This embodiment of this application is performed by a terminal. Referring to FIG. 11, the method includes the following operations.

1101: The terminal displays, in response to a chat initiation operation triggered for a first AI object, a chat interface of the first AI object and a first account.

In a possible implementation, the terminal displays, in an AI object interface, a chat option of the first AI object bound with the first account. If the player wants to chat with the first AI object, the player performs a trigger operation on the chat option of the first AI object. The terminal displays, in response to the trigger operation, the chat interface of the first AI object and the first account.

1102: The terminal receives a message input operation triggered in the chat interface and acquires an interaction message inputted through the message input operation.

The player performs the message input operation in the chat interface to input an interaction message, and the terminal acquires the interaction message inputted by the player. The interaction message is content that the player expects to transmit to the first AI object. In some embodiments, the interaction message may be a text interaction message, a voice interaction message, a picture interaction message, or the like. This is not limited in this embodiment of this application.

1103: The terminal transmits, in response to a message transmitting operation triggered for the interaction message, the interaction message to the first AI object through the first account and displays the interaction message in the chat interface.

After inputting the interaction message, the player performs the message transmitting operation, and the terminal displays, in the chat interface, the interaction message transmitted by the first account to the first AI object in response to the message transmitting operation.

In a possible implementation, when the interaction message does not carry any blocked word, the terminal transmits, in response to the message transmitting operation triggered in the chat interface for the inputted interaction message, the interaction message to the first AI object through the first account and displays the interaction message in the chat interface. Correspondingly, in another embodiment, when the interaction message carries a blocked word, the terminal transmits, in response to the message transmitting operation triggered in the chat interface for the inputted interaction message, the interaction message on which blocking processing has been performed to the first AI object through the first account, and displays the interaction message on which blocking processing has been performed and third prompt information in the chat interface. The blocking processing refers to replacing the blocked word in the interaction message with a target symbol. The third prompt information is configured for prompting not to carry the blocked word when transmitting the interaction message.

In this embodiment of this application, before transmitting the interaction message, the terminal needs to first determine whether the interaction message carries a blocked word. If the interaction message does not carry a blocked word, the terminal normally transmits and displays the interaction message inputted by the first account. If the interaction message carries a blocked word, the blocked word needs to be first replaced with a target symbol. For example, the target symbol is “*”. Then, the interaction message on which blocking processing has been performed is displayed, and meanwhile, the third prompt information is displayed to prompt the player not to carry the blocked word when transmitting the interaction message. For example, the blocked word is a non-civil word, and the third prompt information may be “please chat civilly”.

1104: The terminal transmits, in response to the interaction message, a reply message for the interaction message to the first account through the first AI object and displays the reply message in the chat interface.

After displaying the interaction message transmitted by the first account in the chat interface, the terminal automatically generates the reply message based on the interaction message, then transmits the reply message to the first account through the first AI object, and displays the reply message transmitted by the first AI object in the chat interface so that the first AI object automatically chats with the first account. The reply message may be a text interaction message, a voice interaction message, a picture interaction message, or the like. This is not limited in this embodiment of this application.

In a possible implementation, the process in which the terminal displays, in response to the interaction message, the reply message transmitted by the first AI object in the chat interface includes the following operation 1 to operation 3.

Operation 1: The terminal acquires, in response to the interaction message, a target message reply model whose language style is consistent with the language style of the first AI object among a plurality of message reply models, and invokes the target message reply model to process the interaction message and obtain a text reply message having the language style of the first AI object.

A database stores a plurality of pre-trained message reply models. The plurality of message reply models is configured for generating reply messages of the interaction message. Language styles of the message reply models are different. For example, the language styles may include plain and straightforward, subtle and tactful, humorous and entertaining, childlike, or bold and unrestrained. The terminal first determines the language style of the first AI object, then determines, among the plurality of message reply models, the target message reply model whose language style is consistent with the language style of the first AI object, and inputs the interaction message into the target message reply model. The target message reply model processes the interaction message to output the text reply message having the language style of the first AI object. The text reply message is a reply text for the interaction message.

In this embodiment of this application, the text reply message whose language style is consistent with the language style of the first AI object is obtained by invoking the message reply model so that the text reply message is automatically generated based on the interaction message, and the human-computer interaction process is more intelligent.

Operation 2: The terminal acquires, among a plurality of voice generation models, a target voice generation model whose timbre is consistent with a timbre of the first AI object, and invokes the target voice generation model to convert the text reply message into a voice reply message having the timbre of the first AI object.

The database stores a plurality of pre-trained voice generation models. The plurality of voice generation models are configured for generating voices with particular timbres. The timbres of the voice generation models are different. The timbres may include vivid cartoon character voices, deep male voices, gentle female voices, and the like. The terminal first determines the timbre of the first AI object, then determines, among the plurality of voice generation models, the target voice generation model whose timbre is consistent with the timbre of the first AI object, and inputs the text reply message into the target voice generation model. The target voice generation model converts the text reply message to output the voice reply message having the timbre of the first AI object.

Operation 3: The terminal displays the text reply message and a voice playing option in the chat interface, the voice playing option being configured for triggering to play the voice reply message.

In this embodiment of this application, the text reply message and the voice reply message are obtained using the message reply model and the voice generation model, respectively. When displaying the text reply message, the terminal further displays the corresponding voice playing option. In response to a trigger operation on the voice playing option, the terminal plays the voice reply message having the timbre of the first AI object, thereby imitating a scene in which the first AI object reads the text reply message, improving the entertainment value of human-computer interaction, and facilitating the player to obtain the reply message of the first AI object in multiple manners.

In addition, the player may further set the volume of playing the voice reply message. FIG. 12 is a schematic diagram of a sound effect setting interface according to an embodiment of this application. As shown in FIG. 12, background music, a game sound effect, the volume of an interface sound effect, and the volume of a companion voice may be set in the sound effect setting interface. In this embodiment of this application, an AI object is alternatively referred to as a companion. The volume of the companion voice is the volume at which the AI object reads the text reply message, i.e., the volume at which the voice reply message is played.

In a possible implementation, the terminal transmits, in response to the message transmitting operation triggered for the interaction message, the interaction message to the first AI object through the first account and displays the interaction message in the chat interface if the number of interaction messages transmitted within a preset duration before a current time point does not reach a preset number. Correspondingly, in another embodiment, the terminal displays, in response to the message transmitting operation triggered for the interaction message, first prompt information in the chat interface if the number of interaction messages transmitted within the preset duration before the current time point reaches the preset number. The first prompt information is configured for prompting to reduce a frequency of transmitting the interaction messages.

In this embodiment of this application, if the number of interaction messages transmitted by the first account within the preset duration does not reach the preset number, the terminal normally displays the interaction messages transmitted by the first account. If the number of interaction messages transmitted by the first account within the preset duration reaches the preset number, the frequency of transmitting the interaction messages by the player is excessively high. In this case, the terminal temporarily does not display the interaction messages transmitted by the first account. That is, if the frequency of transmitting the interaction messages by the player is excessively high, the player is not allowed to transmit an interaction message again, and the player is prompted to reduce the frequency of transmitting the interaction messages. Therefore, this avoids the situation where the AI object cannot respond in time due to the player transmitting interaction messages too frequently, thereby affecting the player's social interaction experience.

For example, if the player transmits more than three interaction messages within 10 seconds, the player is prompted that “you speak too quickly” and is not allowed to transmit a fourth interaction message. Only after the cooling time reaches, the player is allowed to transmit an interaction message again.

In a possible implementation, the terminal displays, in response to the interaction message, fourth prompt information. The fourth prompt information is configured for prompting that the first AI object is replying to the interaction message. The terminal cancels displaying the fourth prompt information after generating the reply message based on the interaction message, and displays the reply message in the chat interface.

If the player successfully transmits the interaction message, before the first AI object replies to the interaction message, the terminal may display the fourth prompt information to prompt the player that the first AI object is replying to the interaction message. For example, the fourth prompt information is a character of “replying” displayed behind the name of the first AI object and represents that the first AI object is replying to a message.

In a possible implementation, the terminal determines an intimacy degree between the first account and the first AI object and generates a reply message based on the intimacy degree and the interaction message. An emotional positivity degree expressed by the reply message is positively correlated with the intimacy degree.

There is an intimacy degree between each AI object and the bound account. The intimacy degree may be comprehensively determined based on information in multiple dimensions, for example, the number of times that the account transmits interaction messages with the AI object and the number of times that the account gives gifts to the AI object.

Since the reply message is transmitted by the first AI object to the first account, when the reply message is generated, an intimacy degree between the first account and the first AI object may further be considered. If the intimacy degree between the first account and the first AI object is relatively high, an emotional positivity degree of the generated reply message is relatively high, and if the intimacy degree between the first account and the first AI object is relatively low, an emotional positivity degree of the generated reply message is relatively low.

A relationship between the intimacy degree and the emotional positivity degree of the generated reply message is shown in the following Table 1.

TABLE 1

| Intimacy degree | Emotional positivity degree |
|---|---|
| 0 | Please reply with an apathy attitude |
| 1 | Please reply with an ordinary attitude |
| 2 | Please reply with a general attitude |
| 3 | Please reply with a friendly attitude |
| 4 | Please reply with an enthusiastic attitude |
| 5 | Please reply with an intimate attitude |

In this embodiment of this application, when the reply message is generated, the intimacy degree between the first account and the first AI object is further considered so that an emotional state expressed by the generated reply message changes according to changes of the intimacy degree between the account and the AI object. Therefore, the process of generating the reply message is more intelligent, vividness of the generated reply message is improved, and the generated reply message is prevented from being excessively rigid.

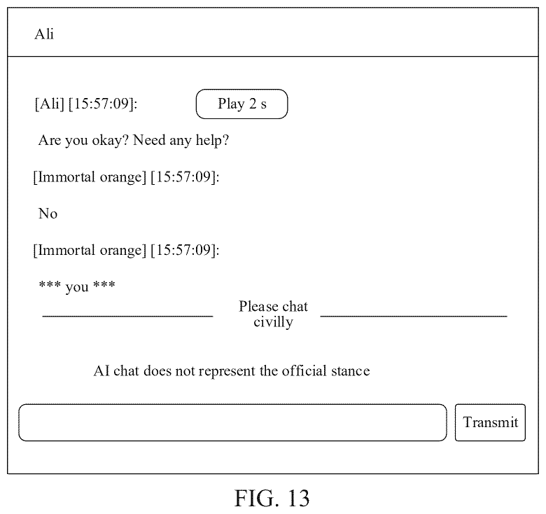

FIG. 13 is a schematic diagram of a chat interface according to an embodiment of this application. As shown in FIG. 13, the chat interface includes a text reply message transmitted by an AI object “Ali” to an account “Immortal orange” and a corresponding voice playing option, and further includes an interaction message transmitted by the account “Immortal orange” to the AI object “Ali”. When the interaction message carries a blocked word, the blocked word is replaced with “*”, and third prompt information “please chat civilly” is displayed.

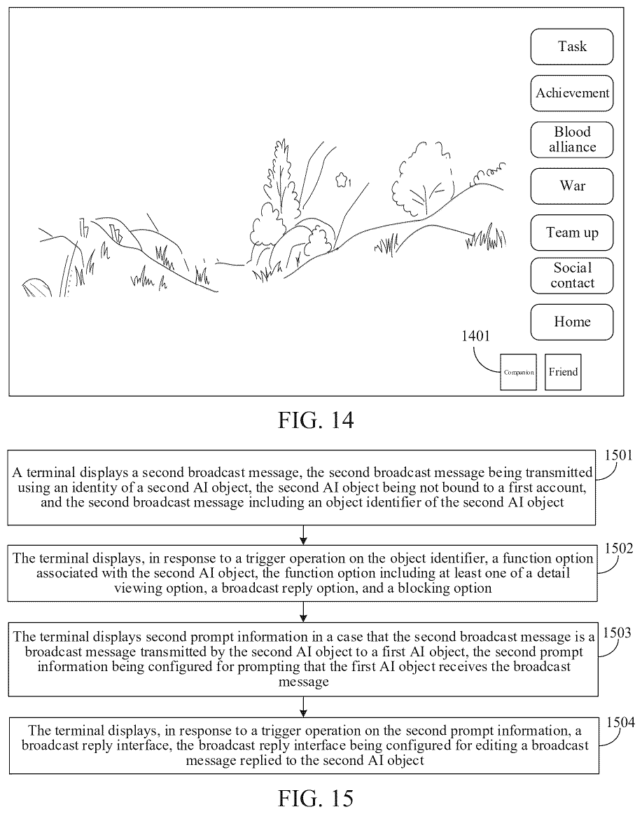

FIG. 14 is a schematic diagram of a lobby interface according to an embodiment of this application. As shown in FIG. 14, a chat interface of an AI object and an account may be further zoomed out into a thumbnail box 1401 displayed on the lower right side of the lobby interface.

According to the method provided in the embodiments of this application, the account and the bound AI object may chat with each other. After the account transmits the interaction message to the AI object, a reply message whose language style is consistent with the language style of the AI object may be automatically generated, and then the AI object transmits the reply message to the account so that the AI object automatically chats with the account, thereby making the human-computer interaction process more intelligent, and improving the entertainment value of human-computer interaction.

The following embodiment shown in FIG. 15 describes a process of displaying a broadcast message transmitted by an AI object bound to another account in detail. FIG. 15 is a flowchart of a message processing method according to an embodiment of this application. This embodiment of this application is performed by a terminal. Referring to FIG. 15, the method includes the following operations.

1501: The terminal displays a second broadcast message, the second broadcast message being transmitted using an identity of a second AI object, the second AI object being not bound to a first account, and the second broadcast message including an object identifier of the second AI object.

The process of transmitting the second broadcast message by the second AI object is the same as the process of transmitting the first broadcast message by the first AI object, and details are not described herein again.

The second AI object is bound to the second account. The terminal on which the second account is logged into transmits the object identifier of the second AI object and the second broadcast message to a game server. The game server transmits the object identifier of the second AI object and the second broadcast message to another terminal. A game application on which another account is logged into runs on the another terminal. The another terminal determines the second AI object according to the object identifier, and then displays the second broadcast message transmitted by the second AI object. Therefore, players in the game application may all see the second broadcast message transmitted by the second AI object. The another terminal described herein includes the terminal on which the first account is logged into.

1502: The terminal displays, in response to a trigger operation on the object identifier, a function option associated with the second AI object, the function option including at least one of a detail viewing option, a broadcast reply option, and a blocking option.

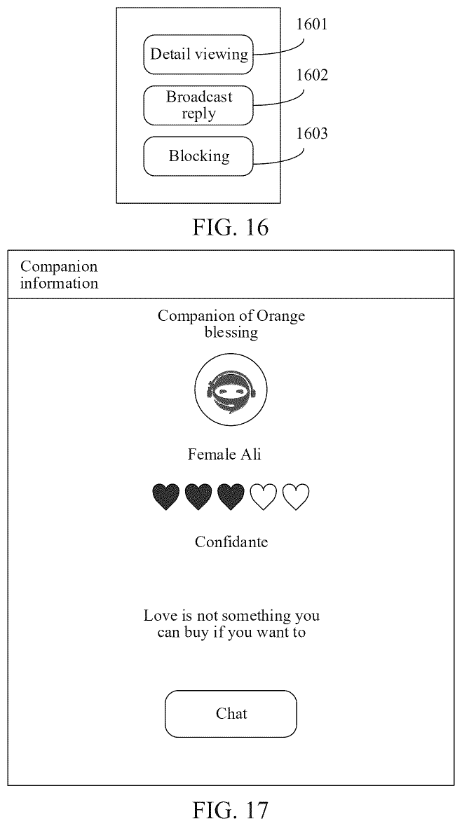

If the player wants to perform another operation on the second AI object, the player may perform the trigger operation on the object identifier of the second AI object, and the terminal displays, in response to the trigger operation on the object identifier, the function option associated with the second AI object. In a possible implementation, as shown in FIG. 16, the terminal displays a detail viewing option 1601, a broadcast reply option 1602, and a blocking option 1603 of function options in a function bar. The detail viewing option, the broadcast reply option, and the blocking option are separately described below.

(1) The detail viewing option is configured for triggering to display a detail interface of the second AI object. The detail interface includes at least one of an account bound to the second AI object or a chat option, and the chat option is configured for triggering to display a chat interface of the second AI object. In addition, the detail interface further includes an avatar and a name of the second AI object, an intimacy degree between the second AI object and the bound account, and the like.

FIG. 17 is a schematic diagram of a detail interface according to an embodiment of this application. As shown in FIG. 17, the detail interface of an AI object “Ali” includes a gender, an avatar, and a name of the AI object “Ali”, a bound account “Orange blessing”, an intimacy degree (represented using hearts) between the AI object “Ali” and the account “Orange blessing”, a relationship of “confidante” between the AI object “Ali” and the account “Orange blessing”, and a personalized signature. The detail interface further includes a chat option. The player may click the chat option to chat with the AI object “Ali”. In some embodiments, if the first account is in a chat whitelist of the second account, the first account may chat with the second AI object of the second account. Otherwise, the first account cannot chat with the second AI object. For example, if the first account cannot chat with the AI object “Ali”, prompt information “Orange blessing does not want you to chat with him/her in private” may be displayed.

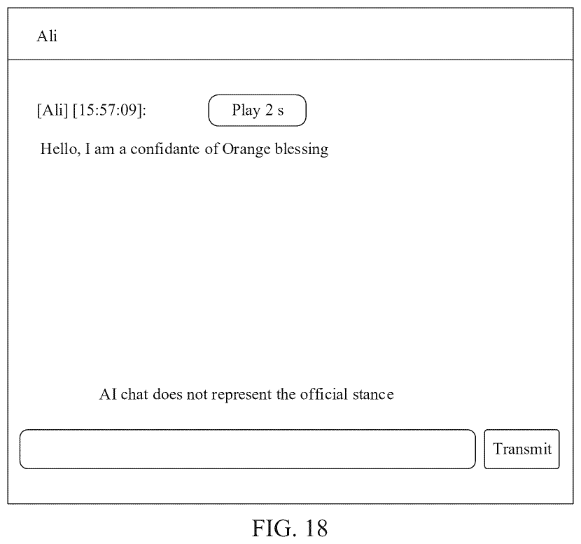

FIG. 18 is a schematic diagram of a chat interface according to an embodiment of this application. As shown in FIG. 18, an interaction message “Hello, I am a confidante of Orange blessing” transmitted by an AI object “Ali” to a first account and a corresponding voice playing option are displayed in the chat interface.

(2) The broadcast reply option is configured for triggering to display a broadcast reply interface, and the broadcast reply interface is configured for editing a broadcast message replied to the second AI object.

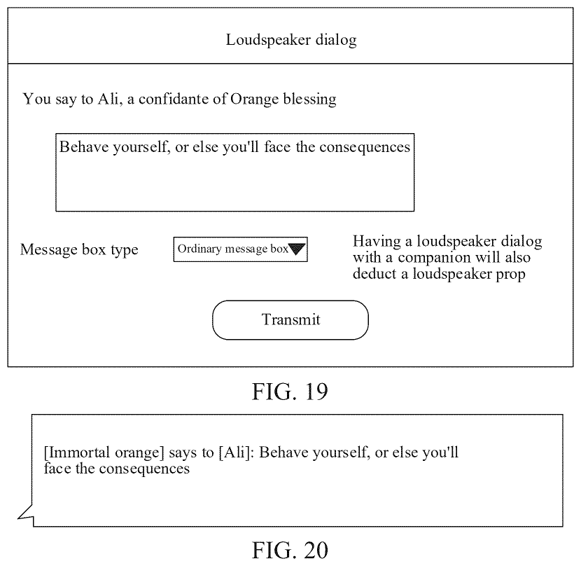

FIG. 19 is a schematic diagram of a broadcast reply interface according to an embodiment of this application. As shown in FIG. 19, a text input box is displayed in the broadcast reply interface. The player may input, in the text input box, a broadcast message replied to an AI object, and a message box configured for carrying the broadcast message may further be set in the broadcast reply interface.

FIG. 20 is a schematic diagram of a broadcast message according to an embodiment of this application. As shown in FIG. 20, the terminal displays a broadcast message replied by a first account “Immortal orange” to a second AI object “Ali”.

(3) The blocking option is configured for triggering to block a message transmitted by the second AI object. After blocking the message transmitted by the second AI object, the terminal does not display various types of messages, such as a broadcast message and an interaction message, transmitted by the second AI object.

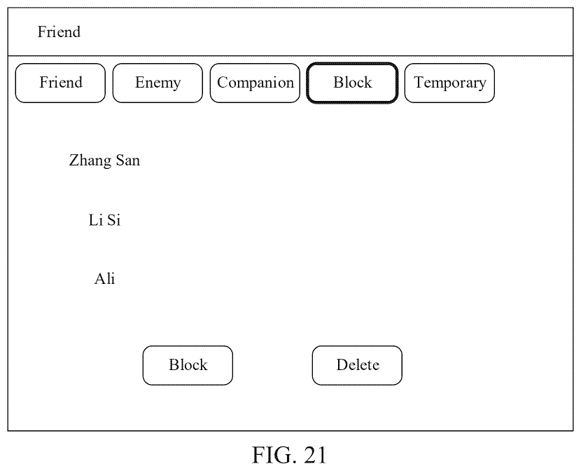

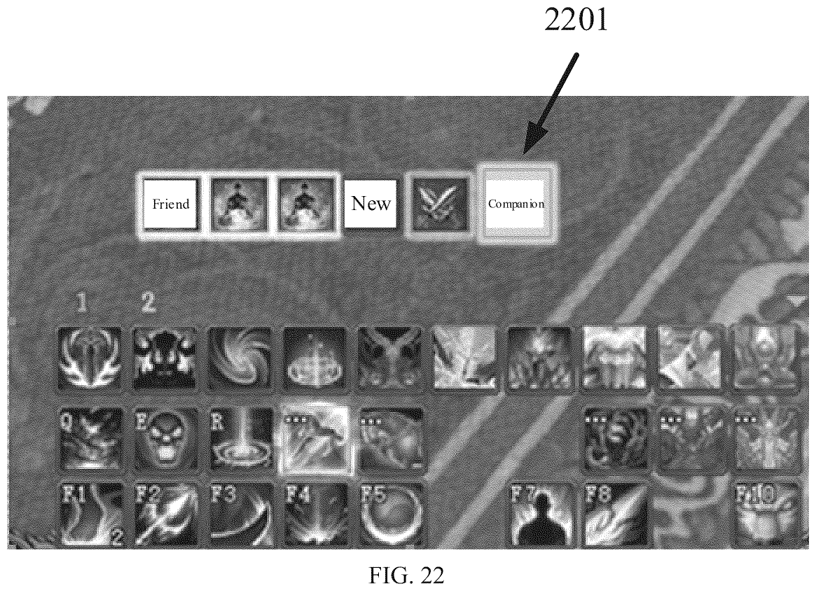

FIG. 21 is a schematic diagram of a blocking interface according to an embodiment of this application. As shown in FIG. 21, after a second AI object “Ali” is blocked, the second AI object “Ali” enters a blocking list of the first account.

1503: The terminal displays second prompt information when the second broadcast message is a broadcast message transmitted by the second AI object to the first AI object, the second prompt information being configured for prompting that the first AI object receives the broadcast message.

If the second broadcast message is specially transmitted by the second AI object to the first AI object, the terminal additionally displays the second prompt information to remind that the first AI object that has a binding relationship with the first account receives the broadcast message, and the player may select to reply to the broadcast message. Therefore, the second prompt message avoids that the player fails to reply to the broadcast message transmitted to the AI object of the player due to not having seen the second broadcast message.

1504: The terminal displays, in response to a trigger operation on the second prompt information, the broadcast reply interface, the broadcast reply interface being configured for editing the broadcast message replied to the second AI object.

If the player wants to reply to the second broadcast message, the player may directly perform the trigger operation on the second prompt information. The terminal displays, in response to the trigger operation, the broadcast reply interface. The player edits, in the broadcast reply interface, the broadcast message replied to the second AI object.

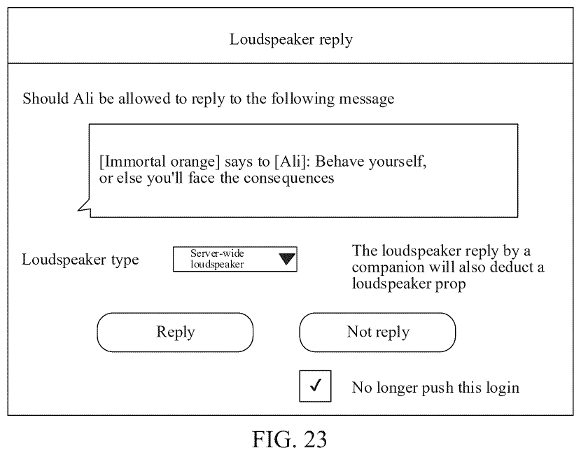

FIG. 22 is a schematic diagram of a lobby interface according to an embodiment of this application. As shown in FIG. 22, if the second broadcast message is specially transmitted by the second AI object to the first AI object, the second prompt information is displayed in the lobby interface. The second prompt information may be a prompt bubble box 2201. If the player wants to reply to the second broadcast message, the player performs a click operation on the prompt bubble box 2201. The terminal displays, in response to the click operation, a broadcast reply interface shown in FIG. 23. The broadcast reply interface displays an automatically generated broadcast message that is transmitted by a first account “Immortal orange” to a second AI object “Ali”.

In this embodiment of this application, the terminal may further display a broadcast message transmitted by an AI object bound to another account and quickly call a function option associated with the AI object by triggering an object identifier of the another AI object, thereby providing a way of quickly viewing a detail interface of the AI object, replying to the broadcast message of the AI object, and blocking the AI object, thereby facilitating active interaction between the player and an AI object of another player, and improving the efficiency of human-computer interaction.

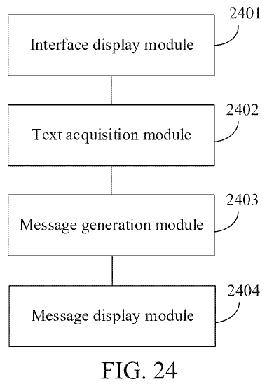

FIG. 24 is a schematic structural diagram of a message processing apparatus according to an embodiment of this application. Referring to FIG. 24, the apparatus includes:
an interface display module 2401 configured to display a message setting interface of a first AI object in a game application, the first AI object being bound to a first account, and the first account being an account currently logged into on the game application;
a text acquisition module 2402 configured to receive a text input operation triggered in the message setting interface, and acquire a text inputted through the text input operation;
a message generation module 2403 configured to generate, in response to a message transmitting operation triggered in the message setting interface, a first broadcast message based on the text and a language style of the first AI object, semantics of the first broadcast message being consistent with semantics of the text, and a language style of the first broadcast message being consistent with the language style of the first AI object; and
a message display module 2404 configured to transmit the first broadcast message using an identity of the first AI object, and displaying the first broadcast message.

According to the message processing apparatus provided in this embodiment of this application, the account of the player has an AI object bound thereto. When a broadcast message is transmitted, after the player inputs a text, the broadcast message may be automatically generated. The broadcast message has semantics consistent with that of the text and has a language style consistent with that of the AI object. Then, the broadcast message is transmitted using an identity of the AI object. This is equivalent to that the player provides content expected to be transmitted, and the AI object reorganizes the language and transmits the broadcast message instead of the player according to the language style of the AI object. Thus, the manner of transmitting the broadcast message improves the entertainment value, thereby improving interaction between the player and the AI object, and helping promote human-computer interaction. In addition, since the language style of the AI object is closer to the game style, the transmitted broadcast message may also be closer to the game style, thereby improving the social experience of the user.

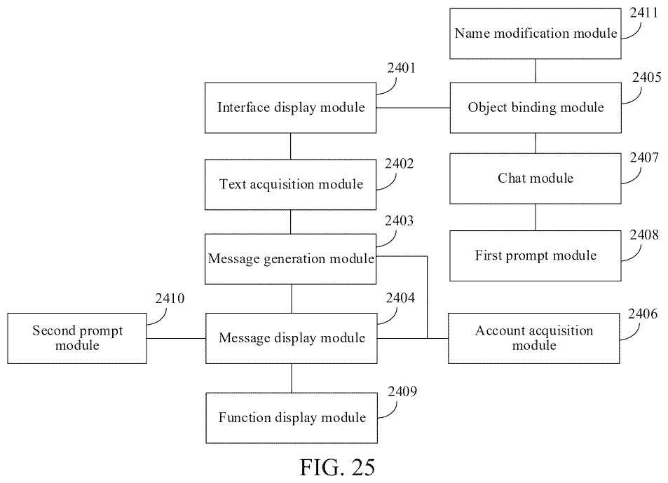

In some embodiments, referring to FIG. 25, the apparatus further includes an object binding module 2405 configured to:
display an object creation interface in the game application;
generate, in response to a creation operation triggered in the object creation interface, a plurality of candidate AI objects, the plurality of candidate AI objects including the first AI object; and
bind, in response to a binding operation triggered for the first AI object, the first AI object to the first account.

In some embodiments, referring to FIG. 25, the object binding module 2405 is configured to:
receive a text input operation triggered in the description input box, and acquire an object description text inputted through the text input operation; and
generate, in response to a trigger operation on the object creation option, a plurality of candidate AI objects matching the object description text.

In some embodiments, referring to FIG. 25, the message generation module 2403 is configured to:
determine, in response to the message transmitting operation, a target text conversion model whose language style is consistent with the language style of the first AI object among a plurality of text conversion models; and
invoke the target text conversion model to perform style conversion on the text and obtain the first broadcast message having the language style of the first AI object.

In some embodiments, referring to FIG. 25, the apparatus further includes:
an account acquisition module 2406 configured to receive an account input operation triggered in the message setting interface, and acquire a second account inputted through the account input operation, the second account being an account in the game application.

The message display module 2404 is configured to:
transmit the first broadcast message to the second account using the identity of the first AI object, and display the first broadcast message.

In some embodiments, referring to FIG. 25, the message generation module 2403 is configured to:
acquire, in response to the message transmitting operation, a first intimacy degree, the first intimacy degree being an intimacy degree between the first account and the second account; and
generate the first broadcast message based on the text, the language style of the first AI object, and the first intimacy degree, an emotional positivity degree of the first broadcast message being positively correlated with the first intimacy degree.

In some embodiments, referring to FIG. 25, the message generation module 2403 is configured to:
delete, in response to the message transmitting operation, a blocked word from the text when the text includes the blocked word, to obtain a processed text; and
generate the first broadcast message based on the processed text and the language style of the first AI object, the semantics of the first broadcast message being consistent with semantics of the processed text.

In some embodiments, referring to FIG. 25, the apparatus further includes a chat module 2407 configured to:
display, in response to a chat initiation operation triggered for the first AI object, a chat interface of the first AI object and the first account;
receive a message input operation triggered in the chat interface, and acquire an interaction message inputted through the message input operation;
transmit, in response to a message transmitting operation triggered for the interaction message, the interaction message to the first AI object through the first account, and display the interaction message in the chat interface; and
transmit, in response to the interaction message, a reply message for the interaction message to the first account through the first AI object, and display the reply message in the chat interface.

In some embodiments, referring to FIG. 25, the chat module 2407 is configured to:
acquire, in response to the interaction message, a target message reply model whose language style is consistent with the language style of the first AI object among a plurality of message reply models, and invoke the target message reply model to process the interaction message and obtain a text reply message having the language style of the first AI object;
acquire, among a plurality of voice generation models, a target voice generation model whose timbre is consistent with a timbre of the first AI object, and invoke the target voice generation model to convert the text reply message into a voice reply message having the timbre of the first AI object; and
display the text reply message and a voice playing option in the chat interface, the voice playing option being configured for triggering to play the voice reply message.

In some embodiments, referring to FIG. 25, the chat module 2407 is configured to:
transmit, in response to the message transmitting operation triggered for the interaction message, the interaction message to the first AI object through the first account, and display the interaction message in the chat interface if the number of interaction messages transmitted within a preset duration before a current time point does not reach a preset number.

The apparatus further includes a first prompt module 2408 configured to:
display, in response to the message transmitting operation triggered for the interaction message, first prompt information in the chat interface if the number of interaction messages transmitted within the preset duration reaches the preset number, the first prompt information being configured for prompting to reduce a frequency of transmitting the interaction messages.

In some embodiments, referring to FIG. 25, the apparatus further includes:
the message display module 2404 further configured to display a second broadcast message, the second broadcast message being transmitted using an identity of a second AI object, the second AI object being not bound to the first account, and the second broadcast message including an object identifier of the second AI object; and
a function display module 2409 configured to display, in response to a trigger operation on the object identifier, a function option associated with the second AI object, the function option including at least one of a detail viewing option, a broadcast reply option, and a blocking option.

The detail viewing option is configured for triggering to display a detail interface of the second AI object, the broadcast reply option is configured for triggering to display a broadcast reply interface, the broadcast reply interface is configured for editing a broadcast message replied to the second AI object, and the blocking option is configured for triggering to block a message transmitted by the second AI object.

In some embodiments, referring to FIG. 25, the apparatus further includes:
a second prompt module 2410 configured to display second prompt information when the second broadcast message is a broadcast message transmitted by the second AI object to the first AI object, the second prompt information being configured for prompting that the first AI object receives the broadcast message.

The interface display module 2401 is further configured to display, in response to a trigger operation on the second prompt information, the broadcast reply interface, the broadcast reply interface being configured for editing the broadcast message replied to the second AI object.

In some embodiments, referring to FIG. 25, the apparatus further includes a name modification module 2411 configured to:
modify, if a first intimacy degree is less than a third intimacy degree, a name of the first AI object when the name of the first AI object is the same as a name of the second AI object, the first intimacy degree being an intimacy degree between the first AI object and the first account, and the third intimacy degree being an intimacy degree between the second AI object and the bound second account; or
modify, if the first intimacy degree is equal to the third intimacy degree, and a first battle parameter is less than a second battle parameter, the name of the first AI object when the name of the first AI object is the same as the name of the second AI object, the first battle parameter representing a battle capability of the first account, and the second battle parameter representing a battle capability of the second account; or
modify the name of the first AI object when the name of the first AI object is the same as a name of any account in the game application.

The message processing apparatus provided in the foregoing embodiment is illustrated only with an example of division of the foregoing function modules. In practical application, the foregoing functions may be allocated to and completed by different function modules according to requirements. That is, the internal structure of the terminal is divided into different function modules to complete all or some of the functions described above. In addition, the message processing apparatus provided in the foregoing embodiment belongs to the same idea as the message processing method embodiment. Details of a specific implementation process may refer to the method embodiment, and details are not described herein again.

The embodiments of this application further provide a terminal, including a processor and a memory, the memory having at least one computer program stored therein, and the at least one computer program being loaded and executed by the processor to implement the operations performed in the message processing method in the foregoing embodiments.

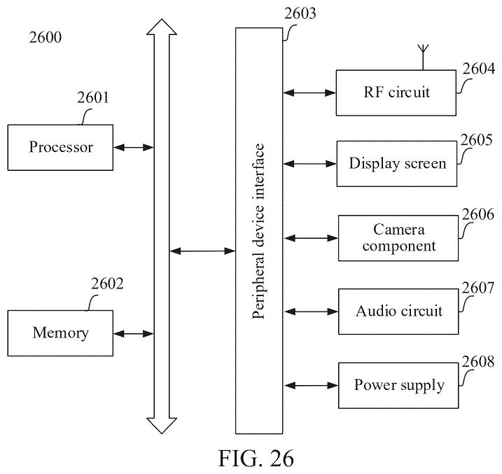

FIG. 26 is a schematic structural diagram of a terminal 2600 according to an exemplary embodiment of this application.

The terminal 2600 includes: a processor 2601 and a memory 2602.

The processor 2601 may include one or more processing cores, for example, a 4-core processor or an 8-core processor. The processor 2601 may be implemented in at least one hardware form of digital signal processing (DSP), a field programmable gate array (FPGA), and a programmable logic array (PLA). The processor 2601 may further include a main processor and a coprocessor. The main processor is a processor configured to process data in an awake status and is alternatively referred to as a central processing unit (CPU). The coprocessor is a low-power-consumption processor configured to process data in a standby state. In some embodiments, the processor 2601 may be integrated with a graphics processing unit (GPU). The GPU is configured to render and draw content that needs to be displayed on a display screen. In some embodiments, the processor 2601 may further include an AI processor. The AI processor is configured to process computing operations related to machine learning.

The memory 2602 may include one or more non-transitory computer-readable storage media. The computer-readable storage medium may be non-transient. The memory 2602 may further include a high-speed random access memory and a nonvolatile memory, for example, one or more disk storage devices or flash storage devices. In some embodiments, the non-transient computer-readable storage medium in the memory 2602 is configured to store at least one computer program. The at least one computer program is used by the processor 2601 to implement the message processing method provided in the method embodiments of this application.

In some embodiments, the terminal 2600 further includes: a peripheral device interface 2603 and at least one peripheral device. The processor 2601, the memory 2602, and the peripheral device interface 2603 may be connected through a bus or a signal line. Each peripheral device may be connected to the peripheral device interface 2603 through a bus, a signal line, or a circuit board. In some embodiments, the peripheral device includes: at least one of a radio frequency (RF) circuit 2604, a display screen 2605, a camera component 2606, an audio circuit 2607, or a power supply 2608.

The peripheral interface 2603 may be configured to connect the at least one peripheral related to input/output (I/O) to the processor 2601 and the memory 2602. In some embodiments, the processor 2601, the memory 2602, and the peripheral device interface 2603 are integrated on the same chip or circuit board. In some other embodiments, any one or two of the processor 2601, the memory 2602, and the peripheral device interface 2603 may be implemented on a single chip or circuit board. This is not limited in this embodiment.

The RF circuit 2604 is configured to receive and transmit an RF signal, referred to as an electromagnetic signal. The RF circuit 2604 communicates with a communication network and other communication devices through the electromagnetic signal. The RF circuit 2604 converts an electrical signal into an electromagnetic signal for transmission, or converts a received electromagnetic signal into an electrical signal. In some embodiments, the RF circuit 2604 includes: an antenna system, an RF transceiver, one or more amplifiers, a tuner, an oscillator, a digital signal processor, a codec chipset, a user identity module card, and the like. The RF circuit 2604 may communicate with another device through at least one wireless communication protocol. The wireless communication protocol includes but is not limited to a metropolitan area network, various generations of mobile communication networks (2G, 3G, 4G, and 5G), a wireless local area network, and/or a wireless fidelity (WiFi) network. In some embodiments, the RF 2604 may further include a circuit related to near field communication (NFC). This is not limited in this application.

The display screen 2605 is configured to display a user interface (UI). The UI may include a graph, a text, an icon, a video, and any combination thereof. When the display screen 2605 is a touch display screen, the display screen 2605 further has a capability of acquiring a touch signal on or above a surface of the display screen 2605. The touch signal may be inputted to the processor 2601 as a control signal for processing. In this case, the display screen 2605 may be further configured to provide a virtual button and/or a virtual keyboard, referred to as a soft button and/or a soft keyboard. In some embodiments, one display screen 2605 may be provided on a front panel of the terminal 2600. In some other embodiments, there may be at least two display screens 2605 provided on different surfaces of the terminal 2600 or in a folded design. In some other embodiments, the display 2605 may be a flexible display provided on a curved surface or a folded surface of the terminal 2600. Even, the display screen 2605 may be further provided in a non-rectangular irregular pattern, i.e., a special-shaped screen. The display screen 2605 may be prepared using materials such as a liquid crystal display (LCD) and an organic light-emitting diode (OLED).

The camera component 2606 is configured to capture images or videos. In some embodiments, the camera component 2606 includes a front camera and a rear camera. The front camera is provided on the front panel of the terminal 2600, and the rear camera is provided on a back surface of the terminal 2600. In some embodiments, there are at least two rear cameras, which are any of main cameras, depth-of-field cameras, wide-angle cameras, and telephoto cameras, to achieve a background blur function through fusion of the main camera and the depth-of-field camera, panoramic photographing and virtual reality (VR) photographing functions through fusion of the main camera and the wide-angle camera, or other fusion photographing functions. In some embodiments, the camera component 2606 may further include a flash. The flash may be a monochrome temperature flash, or may be a double color temperature flash. The double color temperature flash refers to a combination of a warm light flash and a cold light flash, and may be configured for light compensation under different color temperatures.

The audio circuit 2607 may include a microphone and a speaker. The microphone is configured to acquire sound waves of a user and an environment, and convert the sound waves into electrical signals to input to the processor 2601 for processing, or input to the RF circuit 2604 for implementing voice communication. For the purpose of stereo acquisition or noise reduction, there may be a plurality of microphones, provided at different portions of the terminal 2600. The microphone may further be an array microphone or an omni-directional acquisition type microphone. The speaker is configured to convert the electrical signals from the processor 2601 or the RF circuit 2604 into sound waves. The speaker may be a conventional film speaker, or may be a piezoelectric ceramic speaker. When the speaker is the piezoelectric ceramic speaker, the speaker may not only convert the electrical signal into a sound wave audible to the human being, but also convert the electrical signal into a sound wave inaudible to the human being, for ranging and other purposes. In some embodiments, the audio circuit 2607 may further include an earphone jack.

The power supply 2608 is configured to supply power to components in the terminal 2600. The power supply 2608 may be an alternating current, a direct current, a disposable battery, or a rechargeable battery. When the power supply 2608 includes a rechargeable battery, the rechargeable battery may support wired charging or wireless charging. The rechargeable battery may be further configured to support a fast charging technology.

A person skilled in the art may understand that the structure shown in FIG. 26 constitutes no limitation on the terminal 2600, and the terminal may include more or fewer components than those shown in the figure, or a combination of some components, or have a different arrangement of components.

The embodiments of this application further provide a computer-readable storage medium, having at least one computer program stored therein, and the at least one computer program being loaded and executed by a processor to implement the operations performed in the message processing method in the foregoing embodiments.

The embodiments of this application further provide a computer program product, including a computer program, the computer program being loaded and executed by a processor to implement the operations performed in the message processing method in the foregoing embodiments.

A person skilled in the art may understand that all or some of the operations of the foregoing embodiments may be implemented by hardware, or may be implemented by a program instructing relevant hardware. The program may be stored in a computer-readable storage medium. The above-mentioned storage medium may be a read-only memory, a magnetic disk, an optical disc, or the like.

In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module. The above descriptions are merely optional embodiments of the embodiments of this application, and are not intended to limit the embodiments of this application. Any modification, equivalent replacement, improvement, or the like made within the spirit and principle of the embodiments of this application falls within the protection scope of this application.

What is claimed is:

1. A message processing method performed by a terminal, the method comprising:
displaying a message setting interface of a first artificial intelligence (AI) object in a game application, wherein the first AI object is bound to a first account and the first account is an account currently logged into the game application, and the first AI object acts as a companion of the first account in the game application;
receiving a text input operation triggered in the message setting interface, and acquiring a text inputted through the text input operation by a user of the terminal;
in response to a message transmitting operation triggered in the message setting interface, converting the text into a first broadcast message, wherein semantics of the first broadcast message is consistent with semantics of the text, and a language style of the first broadcast message is consistent with a language style of the first AI object; and
transmitting the first broadcast message to a second account of the game application for displaying the first broadcast message at a terminal corresponding to the second account using an identity of the first AI object.

2. The method according to claim 1, further comprising:
before displaying the message setting interface:
displaying an object creation interface in the game application;
in response to a creation operation triggered in the object creation interface, generating a plurality of candidate AI objects; and
in response to a binding operation triggered on one of the plurality of candidate AI objects for the first AI object, setting the first AI object to be the companion of the first account.

3. The method according to claim 2, wherein the object creation interface comprises a description input box and an object creation option, and the generating a plurality of candidate AI objects comprises:
receiving a text input operation triggered in the description input box, and acquiring an object description text inputted through the text input operation by the user of the terminal; and
in response to a trigger operation on the object creation option, generating a plurality of candidate AI objects matching the object description text.

4. The method according to claim 1, wherein the converting the text into a first broadcast message comprises:
determining, in response to the message transmitting operation, a target text conversion model whose language style is consistent with the language style of the first AI object among a plurality of text conversion models; and
invoking the target text conversion model to perform style conversion on the text and obtain the first broadcast message having the language style of the first AI object.

5. The method according to claim 1, wherein the converting the text into a first broadcast message comprises:
in response to the message transmitting operation, deleting a blocked word from the text to obtain a processed text; and
generating the first broadcast message based on the processed text and the language style of the first AI object, the semantics of the first broadcast message being consistent with semantics of the processed text.

6. The method according to claim 1, further comprising:
in response to a chat initiation operation triggered for the first AI object, displaying a chat interface of the first AI object and the first account;
receiving a message input operation triggered in the chat interface, and acquiring an interaction message inputted through the message input operation;
in response to a message transmitting operation triggered for the interaction message, transmitting the interaction message to the first AI object through the first account, and displaying the interaction message in the chat interface; and
in response to the interaction message, transmitting a reply message for the interaction message to the first account through the first AI object, and displaying the reply message in the chat interface.

7. The method according to claim 1, further comprising:
displaying a second broadcast message, the second broadcast message comprising an object identifier of a second AI object; and
in response to a trigger operation on the object identifier, displaying a function option associated with the second AI object, the function option comprising at least one of a detail viewing option, a broadcast reply option, and a blocking option,
wherein the detail viewing option is configured for triggering to display a detail interface of the second AI object, the broadcast reply option is configured for triggering to display a broadcast reply interface, the broadcast reply interface is configured for editing a broadcast message replied to the second AI object, and the blocking option is configured for triggering to block a message transmitted by the second AI object.

8. The method according to claim 7, further comprising:
displaying second prompt information in a case that the second broadcast message is a broadcast message transmitted by the second AI object to the first AI object, the second prompt information being configured for prompting that the first AI object receives the broadcast message; and
displaying, in response to a trigger operation on the second prompt information, the broadcast reply interface, the broadcast reply interface being configured for editing the broadcast message replied to the second AI object.

9. A terminal, comprising a processor and a memory, the memory having at least one computer program stored therein, and the at least one computer program being loaded and executed by the processor to implement a message processing method including:
displaying a message setting interface of a first artificial intelligence (AI) object in a game application, wherein the first AI object is bound to a first account and the first account is an account currently logged into the game application, and the first AI object acts as a companion of the first account in the game application;
receiving a text input operation triggered in the message setting interface, and acquiring a text inputted through the text input operation by a user of the terminal;
in response to a message transmitting operation triggered in the message setting interface, converting the text into a first broadcast message, wherein semantics of the first broadcast message is consistent with semantics of the text, and a language style of the first broadcast message is consistent with a language style of the first AI object; and
transmitting the first broadcast message to a second account of the game application for displaying the first broadcast message at a terminal corresponding to the second account using an identity of the first AI object.

10. The terminal according to claim 9, wherein the method further comprises:
before displaying the message setting interface:
displaying an object creation interface in the game application;
in response to a creation operation triggered in the object creation interface, generating a plurality of candidate AI objects; and
in response to a binding operation triggered on one of the plurality of candidate AI objects for the first AI object, setting the first AI object to be the companion of the first account.

11. The terminal according to claim 10, wherein the object creation interface comprises a description input box and an object creation option, and the generating a plurality of candidate AI objects comprises:
receiving a text input operation triggered in the description input box, and acquiring an object description text inputted through the text input operation by the user of the terminal; and
in response to a trigger operation on the object creation option, generating a plurality of candidate AI objects matching the object description text.

12. The terminal according to claim 9, wherein the converting the text into a first broadcast message comprises:
determining, in response to the message transmitting operation, a target text conversion model whose language style is consistent with the language style of the first AI object among a plurality of text conversion models; and
invoking the target text conversion model to perform style conversion on the text and obtain the first broadcast message having the language style of the first AI object.

13. The terminal according to claim 9, wherein the converting the text into a first broadcast message comprises:
in response to the message transmitting operation, deleting a blocked word from the text to obtain a processed text; and
generating the first broadcast message based on the processed text and the language style of the first AI object, the semantics of the first broadcast message being consistent with semantics of the processed text.

14. The terminal according to claim 9, wherein the method further comprises:
in response to a chat initiation operation triggered for the first AI object, displaying a chat interface of the first AI object and the first account;
receiving a message input operation triggered in the chat interface, and acquiring an interaction message inputted through the message input operation;
in response to a message transmitting operation triggered for the interaction message, transmitting the interaction message to the first AI object through the first account, and displaying the interaction message in the chat interface; and
in response to the interaction message, transmitting a reply message for the interaction message to the first account through the first AI object, and displaying the reply message in the chat interface.

15. The terminal according to claim 9, wherein the method further comprises:
displaying a second broadcast message, the second broadcast message comprising an object identifier of a second AI object; and
in response to a trigger operation on the object identifier, displaying a function option associated with the second AI object, the function option comprising at least one of a detail viewing option, a broadcast reply option, and a blocking option,
wherein the detail viewing option is configured for triggering to display a detail interface of the second AI object, the broadcast reply option is configured for triggering to display a broadcast reply interface, the broadcast reply interface is configured for editing a broadcast message replied to the second AI object, and the blocking option is configured for triggering to block a message transmitted by the second AI object.

16. The terminal according to claim 15, wherein the method further comprises:
displaying second prompt information in a case that the second broadcast message is a broadcast message transmitted by the second AI object to the first AI object, the second prompt information being configured for prompting that the first AI object receives the broadcast message; and
displaying, in response to a trigger operation on the second prompt information, the broadcast reply interface, the broadcast reply interface being configured for editing the broadcast message replied to the second AI object.

17. A non-transitory computer-readable storage medium, having at least one computer program stored therein, and the at least one computer program being loaded and executed by a processor of a terminal and causing the terminal to implement a message processing method including:
displaying a message setting interface of a first artificial intelligence (AI) object in a game application, wherein the first AI object is bound to a first account and the first account is an account currently logged into the game application, and the first AI object acts as a companion of the first account in the game application;
receiving a text input operation triggered in the message setting interface, and acquiring a text inputted through the text input operation by a user of the terminal;
in response to a message transmitting operation triggered in the message setting interface, converting the text into a first broadcast message, wherein semantics of the first broadcast message is consistent with semantics of the text, and a language style of the first broadcast message is consistent with a language style of the first AI object; and
transmitting the first broadcast message to a second account of the game application for displaying the first broadcast message at a terminal corresponding to the second account using an identity of the first AI object.

18. The non-transitory computer-readable storage medium according to claim 17, wherein the method further comprises:
before displaying the message setting interface:
displaying an object creation interface in the game application;
in response to a creation operation triggered in the object creation interface, generating a plurality of candidate AI objects; and
in response to a binding operation triggered on one of the plurality of candidate AI objects for the first AI object, setting the first AI object to be the companion of the first account.

19. The non-transitory computer-readable storage medium according to claim 17, wherein the converting the text into a first broadcast message comprises:
determining, in response to the message transmitting operation, a target text conversion model whose language style is consistent with the language style of the first AI object among a plurality of text conversion models; and
invoking the target text conversion model to perform style conversion on the text and obtain the first broadcast message having the language style of the first AI object.

20. The non-transitory computer-readable storage medium according to claim 17, wherein the converting the text into a first broadcast message comprises:
in response to the message transmitting operation, deleting a blocked word from the text to obtain a processed text; and
generating the first broadcast message based on the processed text and the language style of the first AI object, the semantics of the first broadcast message being consistent with semantics of the processed text.
